(19) United States
(12) Patent Application Publication
(10) Pub. No.: US 2012/0069224 A1
(43) Pub. Date: Mar. 22, 2012

(54) METHOD AND SYSTEM FOR SINGLE-CAMERA LICENSE-PLATE RECOGNITION AND MAGNIFICATION

(76) Inventors: Andrew Cilia, McKinney, TX (US); Robert V. Vanman, McKinney, TX (US); Brent Robertson, Richardson, TX (US)

(21) Appl. No.: 13/095,107

(22) Filed: Apr. 27, 2011

Related U.S. Application Data
(60) Provisional application No. 61/332,147, filed on May 6, 2010.

(51) Int. Cl. H04N 5/262

(52) U.S. Cl. 348/240.99; 348/E05.055

(57) ABSTRACT

A system for recognizing and magnifying an object of interest. The system includes a camera unit and a video processor operable to control the camera unit and detect the object of interest within a field of view of the camera unit. Responsive to detection by the video processor of the object of interest, the system zooms in on the object of interest, captures an image of the object of interest, and zooms out.

### CROSS-REFERENCE TO RELATED APPLICATIONS

This application claims priority from and incorporates by reference U.S. Provisional Patent Application No. 61/332,147 filed May 6, 2010 and entitled METHOD AND SYSTEM FOR SINGLE-CAMERA LICENSE PLATE MAGNIFICATION. In addition, this application incorporates by reference U.S. patent application Ser. No. 12/188,273 filed Aug. 8, 2008, entitled COMBINED WIDE-ANGLE/ZOOM CAMERA FOR LICENSE-PLATE IDENTIFICATION.

### BACKGROUND

1. Field of the Invention

This application relates generally to recognition and magnification of license plates and other objects of interest, and, in particular, to vehicle-mounted license-plate recognition and magnification systems using a single camera for use in law enforcement.

2. History of the Related Art

The ability to effectively recognize and identify license plates is a vital law-enforcement tool used, for example, in the identification of stolen vehicles or individuals with felony warrants. Most commercially-available license-plate-recognition systems employ a fixed-position camera and require the license plate to appear in a field of view of the camera. The limitations of a fixed-position camera, and the consequential reliance on the license plate coming into the camera's field of view, greatly reduce the number of license plates that can be identified, and significantly limit the evidence-gathering capability of the license-plate-recognition systems.

Two-camera license-plate-recognition systems have been developed that employ both a wide-angle camera having license-plate-identification capability and a second camera mounted on a pan/tilt mechanism and having the capability to zoom in on a license plate identified by the wide-angle camera. U.S. patent application Ser. No. 12/188,273 referenced hereinabove describes such a two-camera license-plate-recognition system.

### SUMMARY OF THE INVENTION

A system for recognizing and magnifying an object of interest. The system includes a camera unit and a video processor operable to control the camera unit and detect the object of interest within a field of view of the camera unit. Responsive to detection by the video processor of the object of interest, the system zooms in on the object of interest, captures an image of the object of interest, and zooms out.

A method of recognizing and magnifying an object of interest includes detecting, via a camera unit and a video processor, the object of interest within a field of view of the camera unit, determining coordinates of the object of interest, directing the camera unit to zoom in on the coordinates of the object of interest, and capturing an image of the object of interest.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is a schematic diagram of a single-camera license-plate recognition-and-magnification system;

FIG. 2 is a flow diagram depicting a process for license-plate recognition and magnification; and

FIG. 3 is a flow diagram depicting another process for license-plate recognition and magnification.

### DETAILED DESCRIPTION OF ILLUSTRATIVE EMBODIMENTS OF THE INVENTION

Various embodiments of the present invention will now be described more fully with reference to the accompanying drawings. The invention may, however, be embodied in many different forms and should not be construed as limited to the embodiments set forth herein; rather, the embodiments are provided so that this disclosure will be thorough and complete, and will fully convey the scope of the invention to those skilled in the art.

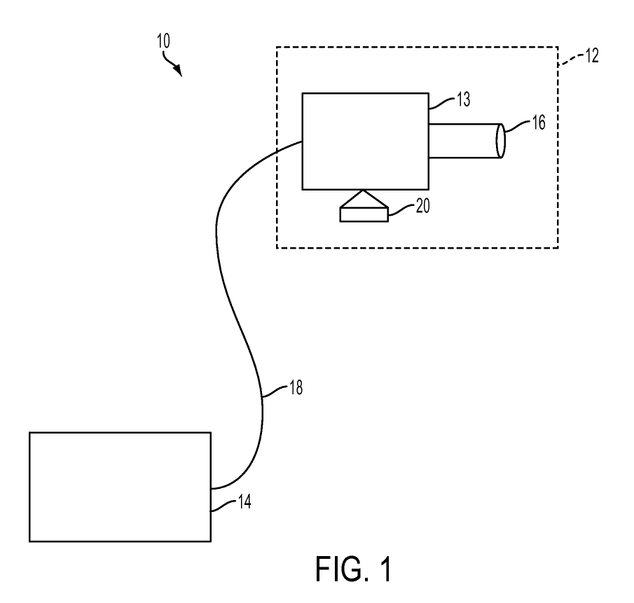

FIG. 1 is a schematic diagram of a single-camera license-plate-recognition-and-magnification system. In FIG. 1, a single-camera license-plate-recognition-and-magnification system 10 includes a camera unit 12 and a video processor 14. The camera unit 12 includes a camera 13 and a pan/tilt mechanism 20. The camera 13 includes a wide-angle/zoom lens 16. The camera 13 may be any appropriate camera, but is typically an infrared camera with active infrared illumination so as to provide sufficient acuity under a variety of lighting conditions. The camera unit 12 is coupled to the video processor 14 via a wired connection 18.

In a typical embodiment, the wide-angle/zoom lens 16 may be used to adjust the field of view of the camera 13 between a zoomed-out mode having a field of view of, for example, approximately 40-50 degrees and a zoomed-in mode having a field of view of, for example, approximately 10 degrees. The camera 13 is mounted on the pan/tilt mechanism 20. The camera unit 12 and the video processor 14, in combination, are capable of identifying and magnifying images of license plates or other objects of interest within a field of view of the camera unit 12.

The pan/tilt mechanism 20 may be used to drive the camera 13 to coordinates provided by the video processor 14. The pan/tilt mechanism 20 may include any device that can be used to point the wide-angle/zoom lens 16 at a particular set of coordinates. The camera unit 12 is operable, in combination with the video processor 14, to point at desired coordinates and zoom in and focus on those coordinates. By way of example, the pan/tilt mechanism 20 is depicted as having a base upon which the camera 13 may pivot both vertically and horizontally.

In some embodiments, the camera unit 12 does not include the pan/tilt mechanism 20. In embodiments not including the pan/tilt mechanism 20, the video processor 14 may detect license plates or other objects of interest that cross a specified region of the field of view of the camera 13. The video processor 14 directs the camera unit 12 to zoom in on the specified region and capture an image of the license plate or other object of interest. In other embodiments, in place of the pan/tilt mechanism 20, a mirror system may be used to optically direct the field of view of the camera 13 to a particular set of coordinates.

In some embodiments, the video processor 14 and the camera unit 12 are contained within the same housing. Additionally, the video processor 14 may include, for example, a computer having video-processing software installed thereon or dedicated video-processing hardware or a combination of both. Although the camera unit 12 is depicted by way of example as being connected to the video processor 14 via the wired connection 18, it is also contemplated that the camera unit 12 could be connected to the video processor 14 by way of a wireless connection.

Zoom capabilities of the camera unit 12 may be accomplished via one or both of digital zoom and a mechanical zoom-lens assembly such as the wide-angle/zoom lens 16. In a typical embodiment, digital zoom is accomplished by the camera unit 12 via use of a multi-megapixel sensor. In some embodiments, an area of interest is passed to the multi-megapixel sensor and the multi-megapixel sensor extracts only those pixels within the area of interest. Decimation or pixel binning may be used to reduce an extracted pixel count so that a large area of interest does not exceed image-processing capabilities, for example, of the video processor 10. In some embodiments, digital zoom and electronic (i.e., non-mechanical) pan/tilt may be achieved by changing the size and position of the area of interest within the multi-megapixel sensor. In a typical embodiment, the multi-megapixel sensor uses a wide-angle lens with a large field of view. Principles of the invention may be applied to systems employing one or both of mechanical zoom and digital zoom as well as one or both of mechanical pan/tilt and electronic pan/tilt.

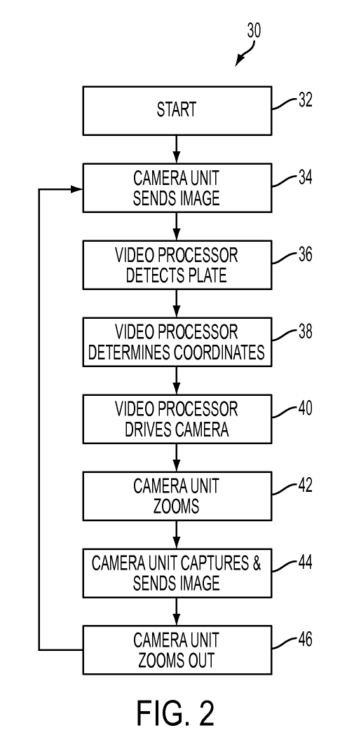

FIG. 2 is a flow diagram depicting a process for license-plate recognition and magnification. In FIG. 2, a process 30 begins at step 32. At step 34, the camera unit 12 sends at least one image to the video processor 14. At step 36, using the at least one image received from the camera unit 12, the video processor 14 detects a license plate or other object of interest that has entered the field of view of the camera unit 12. At step 38, the video processor 14 determines coordinates of the license plate or other object of interest.

At step 40, the video processor 14 drives the camera 13, via the wired connection 18 and the pan/tilt mechanism 20, to the determined coordinates. At step 42, the camera unit 12 utilizes the wide-angle/zoom lens 16 to zoom in on the determined coordinates. In some embodiments, digital zoom may be employed in place of or in addition to the wide-angle/zoom lens 16. In a typical embodiment, during step 42, the video processor 14 tracks the license plate or other object of interest and stabilizes the image thereof. In some embodiments, steps 40 and 42 may be performed in any order or wholly or partially simultaneously.

At step 44, the camera unit 12, utilizing the wide-angle/zoom lens 16 in the zoomed-in mode, captures the image of the license plate or other object of interest. The image may be, for example, a high-resolution image. The camera unit 12 also sends the captured image to the video processor 14 at step 44. In some embodiments, the video processor 14 performs various operations on the received image such as, for example, storage of the image or execution of an optical character-recognition (OCR) operation. At step 46, the camera unit 12 zooms out to return to the zoomed-out mode. From step 46, the process 30 returns to step 34.

In some embodiments, the camera unit 12 may be equipped with digital zoom that permits the camera unit 12 to capture images at twice a typical frame rate and interleave wide and narrow field-of-view images (i.e., zoomed-in and zoomed-out images) on sequential frames. If such a camera unit 12 is employed, one or more of steps 34-38 may occur in parallel to steps 40-44 because both wide and narrow field-of-view images are available concurrently.

In some embodiments, upon detecting a license plate or other object of interest at step 36, the single-camera license-plate-recognition-and-magnification system 10 quickly progresses through steps 38-46. The quick progression through steps 38-46 allows the camera unit 12 to remain in the zoomed-out mode for a longer period of time, thus increasing the evidence-gathering capability of the single-camera license-plate-recognition-and-magnification system 10.

Zooming in and out may occur to various extents in accordance with design constraints. As such the terms “zoomed-out mode” and “zoomed-in mode” are relative terms and need not mean maximal or minimal zoom capabilities of the camera unit 12. Likewise the terms “zoom in” and “zoom out” are also relative terms. As used herein, the term “zoom in” refers to a narrowing of the field of view of the camera 13 relative to a previous state. Similarly, the term “zoom out” as used herein refers to an expansion of the field of view of the camera 13 relative to a previous state.

During step 42, it may sometimes be necessary for the camera unit 12 to track the license plate or other object of interest and stabilize the image thereof. In a typical embodiment, the camera unit 12 zooms in on the coordinates provided by the video processor 14. When the camera unit 12 has at least partially zoomed in on the coordinates, the video processor 14 determines if the license plate or other object of interest is still within the field of view of the camera 13. If the license plate or other object of interest is no longer within the field of view of the camera 13, the video processor 14 directs the camera unit 12 to at least partially zoom out and attempts to re-detect the license plate or other object of interest as described above in step 42. When the license plate or other object of interest is re-detected, the video processor 14 directs the camera unit 12 to zoom in and capture an image of the license plate or other object of interest as described above in steps 42-44.

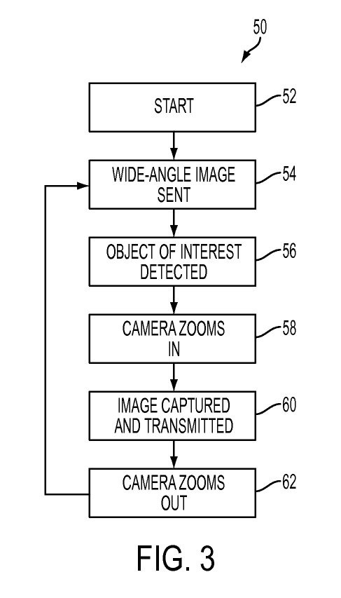

FIG. 3 is a flow diagram depicting a process for license plate-recognition-and-magnification in a system that does not use mechanical pan/tilt. In FIG. 3, a process 50 begins at step 52. At step 54, the camera unit 12 sends at least one image (e.g., a wide-angle image) to the video processor 14. At step 56, using the at least one image received from the camera unit 12, the video processor 14 detects a license plate or other object of interest that has entered a specified region of a field of view of the camera unit 12. At step 58, the camera unit 12 utilizes the wide-angle/zoom lens 16 to zoom in on the specified area. In some embodiments, digital zoom may be in addition to or instead of the wide-angle/zoom lens 16. In a typical embodiment, during step 58, the video processor tracks the license plate or other object of interest and stabilizes the image thereof if needed. In some embodiments, one or both of tracking and stabilization may not be performed.

At step 60, the camera unit 12, utilizing the wide-angle/zoom lens 16 in the zoomed-in mode, captures the image of the license plate or other object of interest. The image may be, for example, a high-resolution image. The camera unit 12 also sends the captured image to the video processor 14 at step 60. In some embodiments, the video processor 14 performs various operations on the received image such as, for example, storage of the image or execution of an optical character-recognition (OCR) operation. At step 62, the camera unit 12 zooms out to return to the zoomed-out mode. From step 62, the process 50 returns to step 54.

As noted above, during step 58 described above, it may sometimes be necessary for the camera unit 12 to track the license plate or other object of interest and stabilize the image thereof. In a typical embodiment, the camera unit 12 zooms in on the specified region of the field of view of the camera 13. When the camera unit 12 has at least partially zoomed in on the specified region, the video processor 14 determines if the license plate or other object of interest is still within the field of view of the camera 13. If the license plate or other object of interest is no longer within the field of view of the camera 13, the video processor 14 directs the camera unit 12 to at least partially zoom out and attempts to re-detect the license plate or other object of interest as described above in step 56. When the license plate or other object of interest is re-detected, the video processor 14 directs the camera unit 12 to zoom in and capture an image of the license plate or other object of interest as described above in steps 58-60.

The single-camera license-plate-recognition-and-magnification system 10 can be equipped with a user interface allowing a user to toggle the single-camera license-plate-recognition-and-magnification system 10 between an active mode and a passive mode. While the single-camera license-plate-recognition-and-magnification system 10 is in the active mode, the single-camera license-plate-recognition-and-magnification system 10 identifies and captures images of license plates or other objects of interest within the field of view of the camera 13 as described above. While in the passive mode, the single-camera license-plate-recognition-and-magnification system 10 functions as a conventional police dashboard camera and does not actively identify or zoom in on license plates or other objects of interest within the field of view of the camera 13.

The single-camera license-plate-recognition-and-magnification system 10 can be adapted to recognize certain environmental events such as, for example, a traffic stop or a high-speed chase, that would trigger the single-camera license-plate-recognition-and-magnification system 10 to switch automatically from passive mode to active mode. The single-camera license-plate-recognition-and-magnification system 10 can be adapted, for example, to detect a high-speed chase based upon the speed of a vehicle. Likewise, the single-camera license-plate-recognition-and-magnification system 10 can be adapted, for example, to detect a traffic stop based upon either the vehicle stopping or light being emitted from an emergency bar on top of the vehicle. By way of example, in the event of a high-speed chase, the single-camera license-plate-recognition-and-magnification system 10, can be adapted to identify, zoom in on, and capture an image of the license plate of a vehicle being pursued. The single-camera license-plate-recognition-and-magnification system 10 can then return the camera unit 12 to zoomed-out mode to capture other events surrounding the chase.

Although various embodiments of the method and system of the present invention have been illustrated in the accompanying Drawings and described in the foregoing Specification, it will be understood that the invention is not limited to the embodiments disclosed, but is capable of numerous rearrangements, modifications and substitutions without departing from the spirit of the invention as set forth herein. For example, although the single-camera license-plate-recognition-and-magnification system 10 has been described herein as being useful to identify vehicular license plates, one skilled in the art would recognize that the single-camera license-plate-recognition-and-magnification system 10 could be used to identify any objects of interest to police officers such as, for example, faces or weapons. In addition, although the single-camera license-plate-recognition-and-magnification system 10 has been described above to capture an image of the license plate or other object of interest only after the camera unit 12 has zoomed in, one skilled in the art will recognize that the single-camera license-plate-recognition-and-magnification system 10 could be designed to capture images during zooming or, alternatively, capture video during zooming. It is intended that the specification and examples be considered as illustrative only.

What is claimed is:

1. A system for recognizing and magnifying an object of interest, the system comprising:
a camera unit;
a video processor operable to control the camera unit and detect the object of interest within a field of view of the camera unit;
wherein, responsive to detection by the video processor of the object of interest, the system zooms in on the object of interest, captures an image of the object of interest, and zooms out.

2. The system of claim 1, wherein the camera unit comprises:
a pan/tilt mechanism; and
a mechanical zoom-lens assembly.

3. The system of claim 1, wherein the camera unit comprises a mirror system operable to cause a specified set of coordinates to be in the field of view.

4. The system of claim 1, comprising:
a user interface operable to toggle the system between an active mode and a passive mode; and
wherein, in the passive mode, the system functions as a conventional dashboard camera.

5. The system of claim 1, wherein:
responsive to an environmental event, the system switches from a passive mode to an active mode; and
the system functions as a conventional dashboard camera in the passive mode.

6. The system of claim 5, wherein the environmental event is a traffic stop or a high-speed chase.

7. The system of claim 1, wherein the camera unit is operable to track the object of interest during zooming in or out.

8. The system of claim 1, wherein the system zooms via at least one of:
a mechanical zoom-lens assembly; and
digital zoom.

9. The system of claim 1, wherein the system concurrently processes wide and narrow field-of-view images.

10. The system of claim 1, wherein the system employs electronic pan/tilt.

11. A method of recognizing and magnifying an object of interest, the method comprising;
detecting, via a camera unit and a video processor, the object of interest within a field of view of the camera unit;
determining coordinates of the object of interest;
directing the camera unit to zoom in on the coordinates of the object of interest; and
capturing an image of the object of interest.

12. The method of claim 11, comprising tracking the object of interest.

13. The method of claim 12, wherein the tracking comprises:
zooming in on the coordinates of the object of interest;
determining if the object of interest is still in the field of view;
re-detecting the object of interest if the object of interest is not in the field of view.

14. The method of claim 11, comprising zooming out the camera unit.

15. The method of claim 11, comprising the camera unit and the video processor detecting a traffic stop or a high-speed chase.

16. The method of claim 15, comprising:
responsive to detecting the traffic stop or the high-speed chase, switching from a passive mode to an active mode; and
wherein the detecting and determining steps are not performed in the passive mode.

17. The method of claim 16, comprising functioning as a conventional dashboard camera when in the passive mode.

18. The method of claim 11, wherein the capturing occurs simultaneously, at least in part, with the directing.

19. The method of claim 11, wherein the zooming is performed via a mechanical zoom-lens assembly.

20. The method of claim 11, wherein the zooming is performed via digital zoom.

21. The system of claim 1, comprising concurrently processing wide and narrow field-of-view images.
